(19) United States
(12) Patent Application Publication
(10) Pub. No.: US 2014/0008870 A1
(43) Pub. Date: Jan. 9, 2014

(54) Shooting Target

(71) Applicant: Peter Martin Skjold Jensen, Regstrup (DK)

(72) Inventor: Peter Martin Skjold Jensen, Regstrup (DK)

(21) Appl. No.: 13/544,008

(22) Filed: Jul. 9, 2012

(51) Int. Cl. F41J 3/00; B23P 19/04

(52) U.S. Cl. 273/348; 29/527.2

(57) ABSTRACT

In a shooting target (2) and a method to manufacture such a shooting target (2), the shooting target (2) has an insulating body member (4), to which body member (4) a covering layer (6) is attached. The insulating body member (4) is made of a material that is capable of allowing a projectile (14, 16) to penetrate the insulating body member (4) and keeping that portion of the insulating body member (4) that has been in contact with the penetrating projectile (14, 16) mechanically connected to the remaining portion of the insulating body member (4).

### BACKGROUND

1. Field of Endeavor

The present invention generally relates to a shooting target. The invention more particularly relates to a thermally insulating shooting target configured to be used for shooting, preferably for shooting with small arms.

2. Brief Description of the Related Art

Shooting targets are well known and described in the prior art. In some shooting applications the shooting targets have an insulating plate-shaped body member made of extruded polystyrene foam. These prior art shooting targets are provided with an outer layer of paper that is glued to the polystyrene foam by hand.

This procedure is time consuming, involves the use of solvent containing compounds (in the glue) which are considered to introduce a health risk.

The paper is a non-tearable paper, however, and it only covers the front surface of the shooting target. Accordingly, the polystyrene prior art shooting targets are easily damaged and they start to crumble. Accordingly, the prior art targets have to be replaced after 2500 shoots or less. The body member, made of extruded polystyrene foam, is difficult to keep within the shooting target and it is a great problem that the “dust” or “debris” is left in nature, since the dust and debris are non-biodegradable.

Thus, there is a need for an insulating target that reduces or even eliminates the above mentioned disadvantages of the prior art.

### SUMMARY

One of numerous aspects of the present invention includes a shooting target that does not crumble when being subject to normal use.

Another aspect includes a shooting target that is stronger and harder (and thus configured to be subject to large wind forces without being damaged) than the prior art shooting targets.

Yet another aspect includes a shooting target that is equipped with an outer layer that does not need to be attached by hand.

Another aspect includes a shooting target that comprises an insulating body member, to which body member a covering layer is attached. The insulating body member is made in a material that is capable of allowing a projectile to penetrate the insulating body member and keeping that portion of the insulating body member that has been in contact with the penetrating projectile mechanically connected to the remaining portion of the insulating body member.

Hereby, it is achieved that the shooting target does not crumble when being subject to normal use. Instead, the shooting target is capable of maintaining its shape in such a way that the body member material is prevented from being torn off the body member by projectiles.

A stronger and harder shooting target is achieved and thus the shooting target is capable of being subject to large wind forces without being damaged.

Additionally, the outer layer may be attached to the body member by using mechanical devices, such as an attachment machine. Accordingly, the covering layer does not need to be attached by hand.

The term “insulating” as used herein means sound insulating. The body member is configured to be used as a shooting target in an acoustic targeting system. It is required that the body member is capable of maintaining its insulating effect even when a large number of projectiles have penetrated the body member. Due to the temperature dependency of the speed of sound, it is required to maintain a relative constant temperature in the interior of the acoustic targeting equipment that the shooting target is intended to be part of, in order to maintain the desired high measurement accuracy of the acoustic targeting equipment.

It is preferred that the insulating body member includes polystyrene.

The body member preferably comprises a solid polystyrene material such as extruded polystyrene foam, often refered to as XPS. The body member is preferably one solid member that is held together without use of any glue or resin.

In another aspect, no crumbling will occur when the shooting target is subject to normal use. Furthermore the shooting target is suitable for being penetrated by a great number of projectiles and still, to a great extent, maintain its shape. The solid polystyrene material is capable of expanding after being penetrated by a projectile so that the size of the remaining projectile hole is minimized. The prior art expanded polystyrene body members includes a plurality of small ball members glued together.

The density of the body member material is preferably in the range 20-70 kg/m³, preferably 28-38 kg/m³, and the melting point is preferably above 75° C., preferably above 180° C.

It may be an advantage that the insulating body member is made in polystyrene or mainly comprises polystyrene.

It may be beneficial that the covering layer is made in a thermoplastic polymer, preferably polypropylene. The covering layer may be made of a polypropylene copolymer such as random copolymer or block copolymer.

A strong, expedient, and highly suitable covering layer may thus be achieved. Such a covering layer may be provided in different thicknesses and it is thus possible to support the body member and stabilize it to such an extent that the shooting target is capable of receiving many more projectiles (e.g., in the size range from 5-10 mm) than the prior art shooting targets.

It is preferred that the polypropylene copolymer is made from extrusion. A homogenous thickness and uniform structure of the covering layer can be therefore achieved. It is moreover possible to manufacture the covering layers in large sheets that may be attached to the body members in a separate process.

Polypropylene is normally tough and flexible and may be copolymerized with ethylene. It may be an advantage to use polypropylene copolymerized with ethylene.

It may be an advantage that the covering layer is based on polypropylene containing reinforcing material (e.g., glass fiber and/or carbon fiber), fillers or additives (e.g., dyes or pigments).

It is preferred that the covering layer has a solid form.

It may be an advantage that the density (at 20° C.) is about 0.8-1.0 g/cm³, preferably about 0.85-0.95 g/cm³.

It may be beneficial that the melting point is above 150° C., preferably above 160° C.

It is preferred that the shooting target comprises a front side, a back side, a top side, a bottom side, a right side and a left side and that the front side and the back side are at least partly covered by the covering layer.

The body member can be supported by the covering layer attached to at least a part of the front side and a part of the back side. At the same time, the top side, the bottom side, the right side and the left side may be provided without any covering layer. In this way it is possible to “only” attach a covering layer to the front side and to the back side. Accordingly, the shooting target is easy and cheap to manufacture.

It is preferred that the covering layer is glued to the body member. This may be done by using any suitable type of glue.

It is also possible to attach the covering layer to the body member by use of other ways, e.g., mechanical or melting procedures.

It is preferred that the covering layer has a homogeneous thickness, which thickness of the covering layer is 0.4-12 mm, preferably, 0.45-1 mm. Research has shown that a thickness of about 0.7 mm provides a long optimum service life of the shooting target, and a strong and reliable covering layer can be achieved.

Another aspect includes a method having the following steps:
providing an insulating body member of a material that is capable of allowing a projectile to penetrate the insulating body member and keeping that portion of the insulating body member that has been in contact with the penetrating projectile mechanically connected to the remaining portion of the insulating body member, where the body member has a front side, a back side, a top side, a bottom side, a right side, and a left side;
attaching a covering layer to the front side and to the back side of the insulating body member so that the covering layer at least partly covers the insulating body member.

Accordingly, a shooting target that does not crumble when being subject to normal use can be provided.

Furthermore, a strong and hard shooting target capable of being subject to large wind forces without being damaged can be achieved.

In addition it is possible to attach the outer layer to the body member by using mechanical processes, such as with an attachment machine, so that the covering layer does not need to be attached by hand.

It is preferred that that the insulating body member is made in polystyrene having a density in the range, 20-70 kg/m³, preferably 28-38 kg/m³ and a melting point above 75° C., preferably above 180° C.

It may be beneficial that a method embodying principles of the present invention comprises the following steps:
attaching a covering layer to essentially the whole front side and the whole back side of the insulating body member so that the covering layer essentially covers the whole front side and the whole back side of the insulating body member.

A reliable shooting target can thus be manufactured in an easy and time saving manner.

Such thermoplastic polymer provides a strong and reliable covering layer. Furthermore, the shooting target may be disposed of as inflammable waste.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIGS. 1a-b show cross-sectional views of a prior art shooting target, and a shooting target according to the invention;

FIGS. 2a-b show cross-sectional views of a prior art shooting target that has been used for shooting purposes, and a shooting target according to the invention that has been used for the same shooting purposes; and

FIG. 3 is a perspective front view of a shooting target according to the invention.

### DETAILED DESCRIPTION OF EXEMPLARY EMBODIMENTS

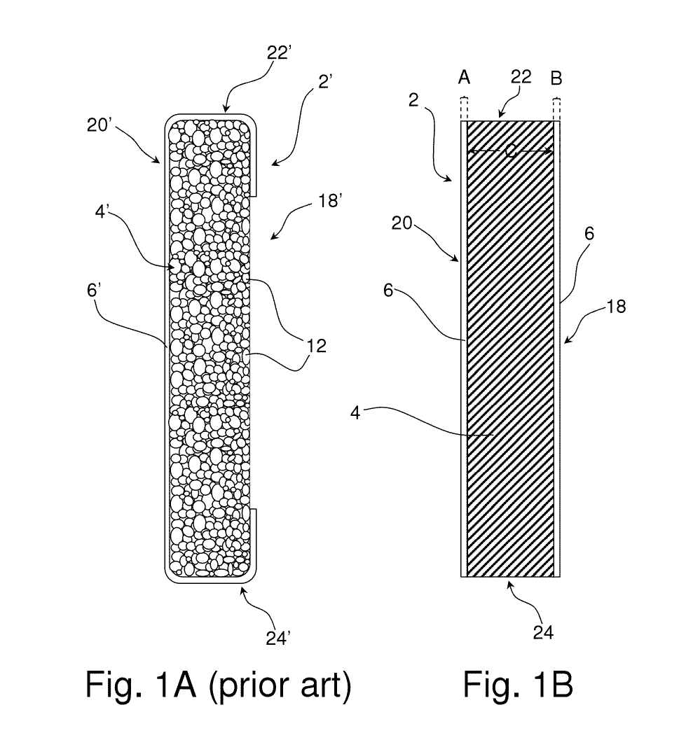

Referring now in detail to the drawings for the purpose of illustrating preferred embodiments of the present invention, a prior art shooting target 2′ is compared with a shooting target 2 according to the invention in FIG. 1.

FIG. 1A shows a schematic cross-sectional view of a prior art shooting target 2′ that includes an insulating body member 4′ made of foam expanded polystyrene. It can be seen from FIG. 1A that the insulating body member 4′ has a plurality of small expanded polystyrene pellets 12 glued together to constitute a plate-shaped body member 4′.

The shooting target 2′ has a front side 20′, a back side 18′, a top side 22′ and a bottom side 24′. A covering layer 6′ has been added to the body member 4′ by hand. The covering layer 6′ covers the front side 20′, the top side 22′ and the bottom side 24′. The covering layer 6′ is also attached to the top portion of the back side 18′ and to the bottom portion of the back side 18′. This means that the majority of the back side 18′ of the body member 4′ is not covered by the covering layer 6′ and thus the back side 18′ is not supported by the covering layer 6′.

The covering layer 6′ is normally glued to the body member 4′ by using a spray type contact adhesive. The covering layer 6′ is typically made of a synthetic material such as flashspun high-density polyethylene fibers sold under the brand “Tyvek”. A flashspun is a nonwoven fabric formed from fine fibrillation of a film by fast evaporation of solvent and subsequent bonding during extrusion.

In comparison, the shooting target shown in FIG. 1B includes a plate-shaped body member 4 made of polystyrene. It is preferred that the body member 4 is made of extruded polystyrene foam, preferably having a density within the range between 0.9-1.4 g/cm³, preferably about 1.16 g/cm³.

A covering layer 6 made of extruded polypropylene (preferably copolymer, e.g., copolymerized with ethylene) is attached to the body member 4. It should be noted that the covering layer 6 is only attached to the front side 20 and the back side 18 of the body member 4 of the shooting target 2.

The covering layer 6 may be glued to the body member 4. It can be seen that a covering layer 6 is attached to both the front side 20 and to the back side 18 of the body member 4. On the other hand, the top side 22 and the bottom side 24 of the body member 4 are not covered by a covering layer 6. The thickness C of the body member 4 is significantly larger than the thickness A of the cover layer 6 attached to the front side 20 and the thickness B of the cover layer 6 attached to the back side 18 of the body member 4 of the shooting target 2.

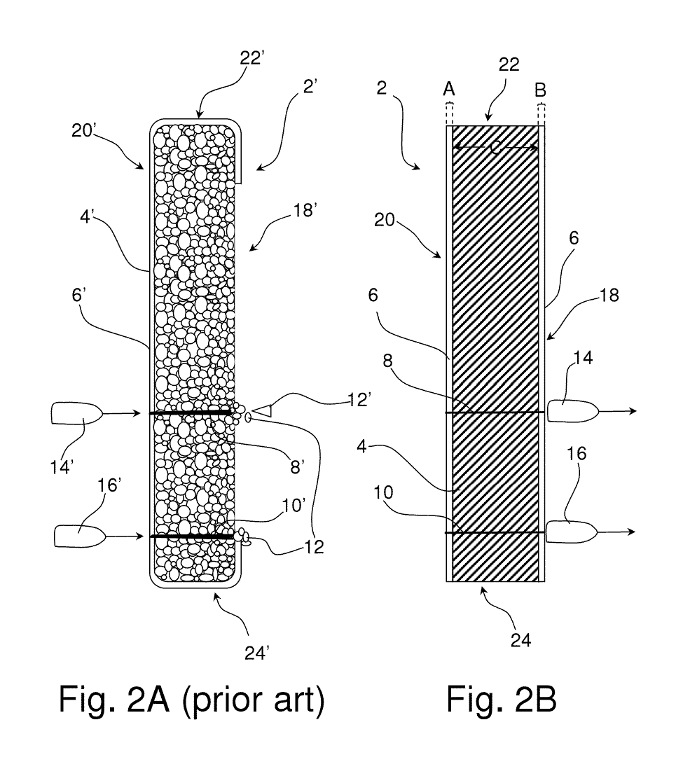

FIG. 2A illustrates a prior art shooting target 2′ that has been used for rifle shooting. Two projectiles 14′, 16′ are fired towards the shooting target 2′ and their traces 8′, 10′ are indicated. Several polystyrene pellets 12 have come lose due to the penetration of the projectiles 14′, 16′ through the body member 4′ of the shooting target 2′. Additionally, a relatively large cone-shaped or pyramid-shaped polystyrene pellet 12′ has been torn away. The polystyrene pellets 12 will fall to the ground and cause pollution of the environment. Moreover, the body member 4′ will gradually crumble away.

FIG. 2B illustrates a shooting target 2 according to principles of the present invention. The shooting target 2 is basically equal to the one shown in FIG. 1B, however, the shooting target 2 has been hit by two projectiles 14, 16. The projectile holes (traces) 8, 10 from the projectiles 14, 16 are indicated in FIG. 2B.

It can be seen that the projectile holes (traces) 8, 10 in the body member 4 of the shooting target 2 according to principles of the present invention are significantly smaller than the projectile holes (traces) 8′, 10′ in the body member 4′ of the prior art shooting target 2′. The body member 4 of the shooting target 2 is capable of compressing or pressing together the projectile holes 8, 10. The two covering layers 6 are glued to the body member 4 and the covering layers 6 are capable of keeping the body member 4 in position so that the shape of the body member 4 can be maintained.

Accordingly, the shooting target 2 is capable of resisting many more (up to ten times more) shots than the prior art shooting target 2′.

It is possible to manufacture the covering layer 6 and the body member 4 separately and join the members mechanically, e.g., by glue added by use of an attachment machine. The thickness C of the body member 4 is significantly larger than the thicknesses A, B of the cover layer 6 attached to the front side 20 and the back side 18 of the body member 4 of the shooting target 2. It is possible to attach a sheet with figures to the covering layer 6. Alternatively, figures may be painted directly to the covering layer 6 by hand. Figures may also be provided by any other suitable process (e.g. screen printing).

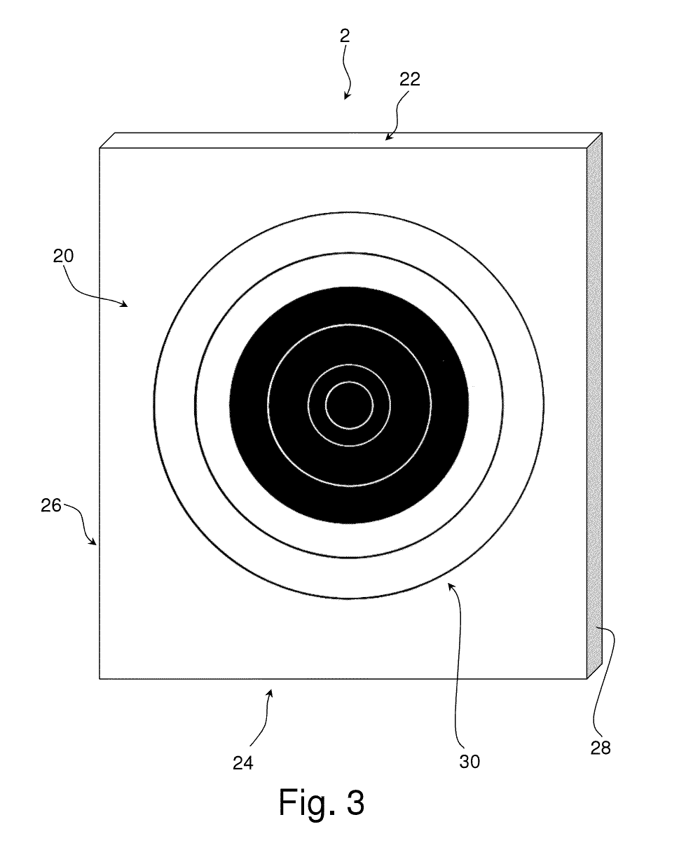

FIG. 3 illustrates a perspective front view of an exemplary shooting target 2 according to principles of the present invention. The shooting target 2 corresponds to the shooting targets 2 shown in FIG. 1B and in FIG. 2B. The shooting target 2 illustrated in FIG. 3 has a front side 20, a top side 22, a bottom side 24, a left side 28 and a right side 26.

A shooting target sheet 30 is provided on the front side 20 of the shooting target 2.

### LIST OF REFERENCE NUMERALS

2, 2′—Shooting target

4, 4′—Body member

6, 6′—Covering layer

8, 8′—Projectile hole

10, 10′—Projectile hole

12, 12′—Polystyrene pellet

14, 14′—Projectile

16, 16′—Projectile

18, 18′—Back side

20, 20′—Front side

22, 22′—Top side

24, 24′—Bottom side

26—Right side

28—Left side

30—Shooting target sheet

A, B—Thickness

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims. While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A shooting target comprising:
an insulating body member; and
a covering layer attached to the insulating body member;
wherein the insulating body member is made in a material that is capable of allowing a projectile to penetrate the insulating body member and keeping that portion of the insulating body member that has been in contact with the penetrating projectile mechanically connected to the remaining portion of the insulating body member.

2. A shooting target according to claim 1, wherein the insulating body member comprises solid polystyrene.

3. A shooting target according to claim 1, wherein the insulating body member consists essentially of solid polystyrene.

4. A shooting target according to claim 1, wherein the covering layer is made of a thermoplastic polymer.

5. A shooting target according to claim 1, wherein the covering layer is made of polypropylene.

6. A shooting target according to claim 1, wherein the covering layer is made of polypropylene copolymer.

7. A shooting target according to claim 1, wherein the covering layer is made of random copolymer or block copolymer.

8. A shooting target according to claim 4, wherein the polypropylene copolymer is made from extrusion.

9. A shooting target according to claim 1, wherein:
the insulating body member comprises a front side, a back side, a top side, a bottom side, a right side, and a left side; and
the front side and the back side are at least partly covered by the covering layer.

10. A shooting target according to claim 1, wherein the covering layer is glued to the insulating body member.

11. A shooting target according to claim 1, wherein the covering layer has a homogeneous thickness A between 0.4-12 mm.

12. A shooting target according to claim 1, wherein the covering layer has a homogeneous thickness A between 0.45-1 mm.

13. A method for manufacturing a shooting target having an insulating body member, the method comprising:
providing an insulating body member of a material that is capable of allowing a projectile to penetrate the insulating body member and keeping that portion of the insulating body member that has been in contact with the penetrating projectile mechanically connected to the remaining portion of the insulating body member, where the insulating body member has a front side, a back side, a top side, a bottom side, a right side, and a left side;
attaching a covering layer to the front side and to the back side of the insulating body member so that the covering layer at least partly covers the insulating body member.

14. A method for manufacturing a shooting target according to claim 13, wherein the insulating body member is made of polystyrene.

15. A method according to claim 13, wherein attaching comprises attaching a covering layer to essentially the whole front side and the whole back side of the insulating body member so that the covering layer essentially covers the whole front side and the whole back side of the insulating body member.

16. A method according to claim 13, wherein the covering layer is made of a thermoplastic polymer.

17. A method according to claim 13, wherein the covering layer is made of polypropylene.

18. A method according to claim 13, wherein the covering layer is made of polypropylene copolymer.

19. A method according to claim 13, wherein the covering layer is made of random copolymer or block copolymer.
